(19) United States
(12) Patent Application Publication
(10) Pub. No.: US 2013/0094467 A1
(43) Pub. Date: Apr. 18, 2013

(54) DEVICE AND METHOD FOR RECONFIGURING COMPONENT CARRIER IN WIRELESS COMMUNICATION SYSTEM THAT OPERATES PLURALITY OF COMPONENT CARRIERS, AND DEVICE AND METHOD FOR TRANSMITTING RRC CONNECTION-RECONFIGURATION MESSAGE THEREFOR

(71) Applicants: Kibum Kwon, Seoul (KR); Myungcheul Jung, Seoul (KR)

(72) Inventors: Kibum Kwon, Seoul (KR); Myungcheul Jung, Seoul (KR)

(73) Assignee: PANTECH CO., LTD., Seoul (KR)

(21) Appl. No.: 13/806,479

(22) PCT Filed: Jun. 16, 2011
(86) PCT No.: PCT/KR2011/004397

§ 371 Date: Dec. 21, 2012

(30) Foreign Application Priority Data
Jun. 21, 2010 (KR) 10-2010-0058809

(51) Int. Cl. H04W 72/04

(52) U.S. Cl. CPC H04W 72/042
USPC 370/329

(57) ABSTRACT

The present description relates to a device and a method for reconfiguring a component carrier (CC) of a UE in a wireless communication system that operates a plurality of CCs. The UE receives an RRC connection-reconfiguration message, performs a CC reconfiguration procedure for adding, modifying, and releasing functions or the like of a corresponding CC for the UE by using CC configuration information contained in a CC connection reconfiguration message, and generates a CC reconfiguration completed message to transmit the generated message to an eNB. Since the present description defines CC index information mapped into each CC by using CC unique information, later the CCs can be divided by using only the received CC index information even without the CC unit information, where by efficient CC reconfiguration plans are made.

### CROSS-REFERENCE TO RELATED APPLICATIONS

This Application is the National Stage Entry of International Application No. PCT/KR2011/004397, filed on Jun. 16, 2011, and claims priority from and the benefit of Korean Patent Application No. 10-2010-0058809, dated Jun. 21, 2010, all of which are incorporated herein by reference for all purposes as if fully set forth herein.

### BACKGROUND

1. Field

The present invention relates to a wireless communication system, and more particularly, to a CC reconfiguring device and method in a wireless communication system that operates a plurality of component carriers (Component Carrier; hereinafter referred to as a ‘CC’) and an RRC connection reconfiguration message transmitting device and method.

2. Discussion of the Background

As communication systems have developed, various wireless terminals have been utilized by consumers, such as companies and individuals.

A current mobile communication system may be a high capacity communication system capable of transmitting and receiving various data such as image data, wireless data, and the like, beyond providing a sound-based service. Accordingly, there is a desire for a technology that transmits high capacity data, which is comparable with a wired communication network. Also, the system is required to include an appropriate error detection scheme that minimizes loss of information and increases transmission efficiency of the system so as to enhance performance of the system.

Unlike a current communication system that uses a single carrier, formed of a single frequency band, a recently discussed wireless communication system may consider a scheme that uses a plurality of CCs.

As described in the foregoing, in the communication system that uses the plurality of CCs, each CC may function as a single cell and thus, the recently discussed wireless communication system may need to dynamically perform reconfiguration of a CC allocated to a UE. However, detailed schemes for the above have not been defined.

### SUMMARY

Therefore, the present invention has been made in view of the above-mentioned problems, and an aspect of the present invention is to provide a CC reconfiguring device and method in a wireless communication system that operates a plurality of CCs, and a radio resource control (hereinafter referred to as ‘RRC’) connection reconfiguration message transmitting device and method.

Another aspect of the present invention is to provide a CC reconfiguring device and method that performs CC reconfiguration using CC configuration information or an RRC connection reconfiguration message when reconfiguration of a few of the CCs allocated to a UE is required in a communication system that uses multiple CCs.

Another aspect of the present invention is to provide a device and method that defines CC index information that is mapped to each CC based on CC unique information.

Another aspect of the present invention is to provide a device and method that generates and transmits an RRC connection reconfiguration message including CC configuration information for CC reconfiguration.

In accordance with an aspect of the present invention, there is provided a CC reconfiguring device in a communication system that uses multiple CCs, the device including: a message transmitting/receiving unit to receive an RRC connection reconfiguration message; a CC configuration-information confirmation unit to determine CC configuration information is included in the received RRC connection reconfiguration message; and a CC determination unit to perform one or more CC reconfigurations from among CC addition, CC modification, and CC release based on the CC configuration information.

In accordance with another aspect of the present invention, there is provided a CC reconfiguration method of a CC reconfiguring device in a communication system that uses multiple component carriers, the method including: receiving an RRC connection reconfiguration message; determining CC configuration information included in the RRC connection reconfiguration message; performing CC reconfiguration by performing one or more procedures from among CC addition (Add), CC modification (Mod), and CC release (Release) based on the CC configuration information; and generating and transmitting an RRC connection reconfiguration complete message to an eNB and the like.

In accordance with another aspect of the present invention, there is provided an RRC connection reconfiguration message transmitting device in a communication system that uses multiple CCs, the device including: a CC configuration information generating unit to generate, for each CC, CC configuration information to include one or more information from among CC unique information and separate CC index information that matches the CC unique information; an RRC connection reconfiguration message generating unit to generate an RRC connection reconfiguration message to include the CC configuration information; a message transmitting unit to transmit the generated RRC connection reconfiguration message; and an RRC connection reconfiguration complete message receiving unit to receive an RRC connection reconfiguration complete message.

In accordance with another aspect of the present invention, there is provided an RRC connection reconfiguration message transmitting method of an RRC connection reconfiguration message transmitting device in a communication system that uses multiple CCs, the method including generating, for each CC, CC configuration information to include one or more information from among CC unique information and separate CC index information that matches the CC unique information; generating an RRC connection reconfiguration message to include the CC configuration information; transmitting the generated RRC connection reconfiguration message; and receiving an RRC connection reconfiguration complete message.

### BRIEF DESCRIPTION OF THE DRAWINGS

FIG. 1 is a diagram illustrating a wireless communication system according to an embodiment of the present invention;

FIG. 2 is a diagram illustrating an example of a CC used in embodiments of the present invention;

FIG. 3 is a diagram illustrating an RRC connection reconfiguration process between a UE and an eNB according to an embodiment of the present invention;

FIG. 4 is a diagram illustrating a scheme that establishes a linkage between a downlink and an uplink in a wireless communication system that operates a plurality of downlink frequency bands and uplink frequency bands according to an embodiment of the present invention;

FIG. 5 is a functional block diagram illustrating a CC reconfiguring device according to an embodiment of the present invention;

FIG. 6 is a flowchart illustrating a CC reconfiguration method according to an embodiment of the present invention;

FIGS. 7 and 8 are diagrams illustrating a CC reconfiguration process according to an embodiment of the present invention;

FIG. 9 is a functional block diagram illustrating an RRC connection reconfiguration message transmitting device according to an embodiment of the present invention; and

FIG. 10 is a flowchart illustrating an RRC connection reconfiguration message transmitting method according to an embodiment of the present invention.

### DETAILED DESCRIPTION OF THE ILLUSTRATED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

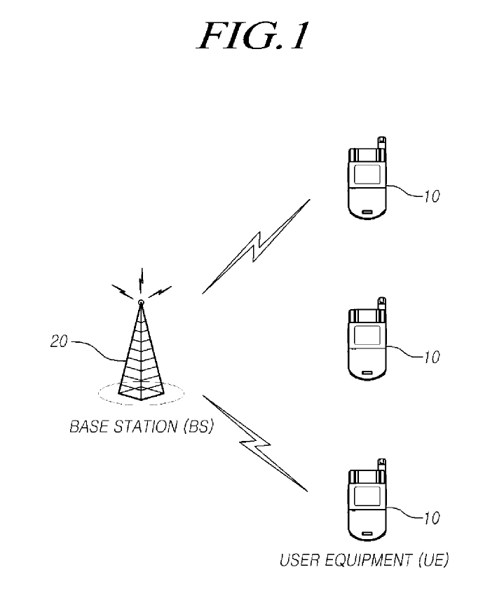

FIG. 1 illustrates a wireless communication system according to embodiments of the present invention.

The wireless communication system may provide various communication services such as voice data, packet data, and the like.

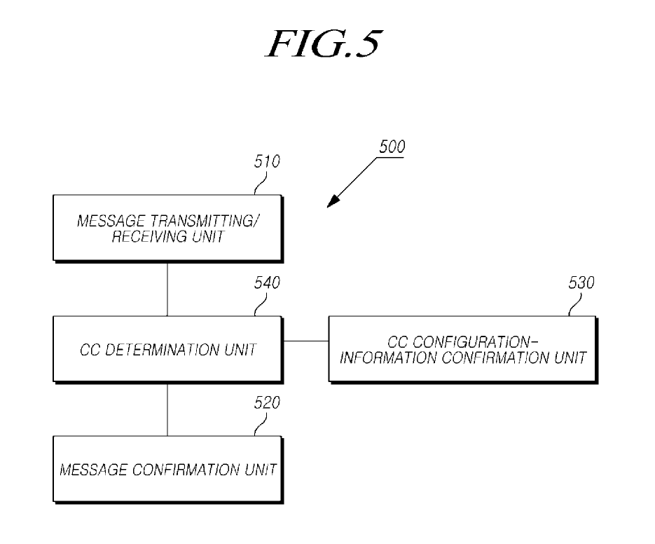

Referring to FIG. 1, the wireless communication system may include a User Equipment (hereinafter referred to as a ‘UE’) 10 and an evolved-Node B (hereinafter referred to as an ‘eNB’) 20. A CC reconfiguration technology and a RRC connection reconfiguration message transmitting technology used therefor may be applied to the UE 10 and the eNB 20. The CC reconfiguration technology and the RRC connection reconfiguration message transmitting technology will be described from the descriptions of FIG. 5.

The UE 10 may be a term including an MS (Mobile Station), a UT (User Terminal), an SS (Subscriber Station), a wireless device and the like.

The eNB or a cell may be a fixed station that performs communication with a UE, and may be referred to as a Node-B, a sector, a site, a BTS (Base Transceiver System), an access point, a relay node, and the like.

The eNB may be construed as an inclusive concept indicating a function or a portion of an area covered by a BSC (Base Station Controller) in CDMA, a Radio Network Controller (RNC) in WCDMA, and the like. Also, the eNB may include various cell coverage areas, such as a megacell, a macrocell, a microcell, a picocell, a femtocell, a communication range of a relay node, and the like.

In embodiments of the present invention, uplink transmission and downlink transmission may be performed based on a Time Division Duplex (TDD) scheme that performs transmission based on different times, or based on a Frequency Division Duplex (FDD) scheme that performs transmission based on different frequencies.

Embodiments of the present invention will be described using a wireless communication system as an example, particularly, a next generation wireless communication system that supports a plurality of component carriers. An embodiment of the present invention may be applicable to an asynchronous wireless communication system that is advanced through GSM, WCDMA, and HSPA, to be LTE (Long Term Evolution) and LTE-A (LTE-advanced), and may be applicable to a synchronous wireless communication system that is advanced through CDMA and CDMA-2000, to be UMB.

The wireless communication system according to embodiments of the present invention may support an uplink and/or downlink HARQ, and may use a CQI (channel quality indicator) for link adaptation. Also, a multiple access scheme for downlink transmission and a multiple access scheme for uplink transmission may be different from each other. For example, a downlink may use OFMDA (Orthogonal Frequency Division Multiple Access) and an uplink may use SC-FDMA (Single Carrier-Frequency Division Multiple Access).

Layers of a radio interface protocol between a UE and a network may be distinguished as a first layer (L1), a second layer (L2), and a third layer (L3), based on three lower layers of a well-known Open System Interconnection (OSI) model in a communication system, and a physical layer of the first layer may provide an information transfer service through use of a physical channel.

A currently used communication system uses a single carrier having a predetermined frequency bandwidth (up to 20MHz), and the wireless communication system may transmit and receive System Information (hereinafter referred to as ‘SI’) associated with a single CC through a corresponding CC.

However, a recently discussed new communication system has discussed extension of a bandwidth to satisfy required performance. In this example, a unit carrier that a communication UE may conventionally have may be defined to be a CC (Component Carrier), and discussion about a scheme that binds up to N CCs (Component Carriers) (N may correspond to 5) is in progress.

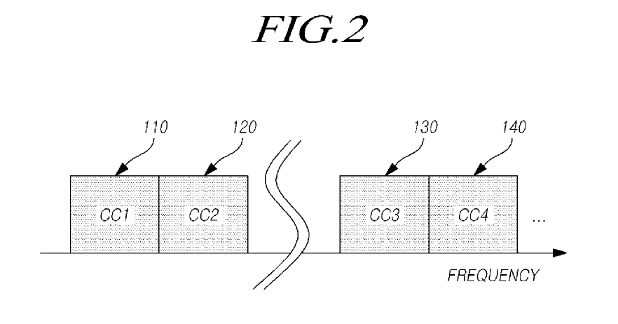

FIG. 2 is a diagram illustrating an example of a CC that may be used in embodiments of the present invention.

As illustrated in FIG. 2, an LTE/LTE-A system may be used for expanding a bandwidth to satisfy a system requirement, that is, a high data transmission rate, and may use a plurality of CCs which are unit carriers. Here, a single CC may have a maximum bandwidth of 20 MHz. Resource allocation may be performed within a bandwidth of 20 MHz depending on a corresponding service. Depending on a configuration of a system, a single CC may be configured to have a bandwidth greater than or equal to 20 MHZ.

Also, a next generation communication system may define the use of a component carrier aggregation or carrier aggregation (hereinafter referred to as ‘CA’) that binds a plurality of CCs and uses the bound CCs as a single system band. For example, a wireless communication system according to an embodiment of the present invention supports an expanded service quality by expanding a bandwidth up to 100 MHz when five component carriers each of which has a maximum bandwidth of 20 MHz are used.

A frequency band that may be determined by component carriers, that is, a frequency band allocable through component carriers, may be contiguous or non-contiguous.

Here, a CC may be indicated by a name, such as CC0, CC1, and the like. In this example, a number included in a name of each CC may not always match an order of a corresponding CC or a location of a frequency band of the corresponding CC

For example, the wireless communication system may include CC1, CC2, CC3, . . . , CCN, and an uplink (UL) or a downlink (DL) allocated to each CC may be different from each other, or may be the same as one another based on a scheduler.

Recently discussed items in association with the above may include that 1) a UE configures a UE-specific CC set in each cell, 2) RRC connection is established through a single cell from among the configured CC set, and 3) each CC is distinguished through use of a carrier indicator of 3 bits.

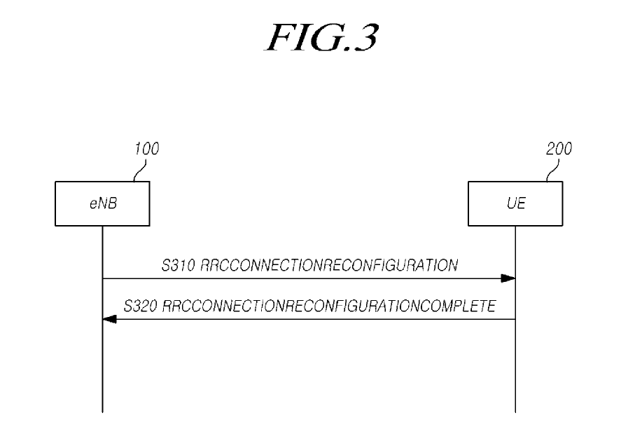

FIG. 3 is a diagram illustrating an RRC connection reconfiguration process between a UE and an eNB according to an embodiment of the present invention. That is, FIG. 3 shows a process of performing RRC connection reconfiguration between a UE and an eNB through a downlink frequency band and an uplink frequency band in which an RRC connection is set.

Referring to FIG. 3, an eNB 100 transmits an RRC connection reconfiguration message (RRCConnectionReconfiguration) to a UE to reconfigure a current RRC connection establishment in step S310.

In this example, the UE determines the RRC connection reconfiguration message received from the eNB and adds, modifies, or releases setting parameters required for wireless communication with the eNB, and generates and transmits an RRC reconfiguration complete message (RRCConnectionReconfigurationComplete) to the eNB in step S320.

The RRC connection reconfiguration procedure of FIG. 3 may be performed in the following situations, but this may not be limited thereto.
setting, modifying, or releasing of a Radio Bearer (RB)
handover
setting, modifying, or releasing of measurement
a case in which an eNB performs a procedure of transferring NAS dedicated (Non Access Stratum dedicated) information to a UE.

Here, the NAS (Non Access Stratum) refers to a functional layer in a wireless communication protocol stack between a core network and a UE, and may refer to a most upper layer that performs UE authentication between a UE and an upper layer, controlling of security, paging of a UE in an LTE_IDLE mode, and managing of movement, and the like.

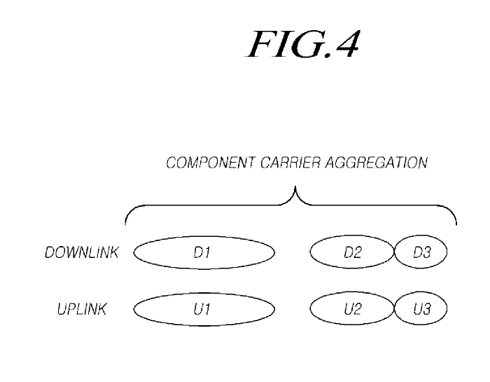

FIG. 4 is a diagram illustrating a scheme that establishes a linkage between a downlink and an uplink in a wireless communication system that operates a plurality of downlink frequency bands and uplink frequency bands according to an embodiment of the present invention.

FIG. 4 describes an LTE-A (LTE-Advanced) system, which is a recently discussed next generation communication system, as a wireless communication system according to an embodiment of the present invention.

CCs may establish a linkage between a downlink CC and an uplink CC as shown in FIG. 4. Each linkage may be set to be a cell-specific linkage or a UE-specific linkage.

The linkage may be set based on information included in SI received in a UE through a downlink CC, or may be set through an RRC signaling, but this may not be limited thereto.

For example, a UE in an IDLE mode selects a single downlink (DL) CC for RRC connection, and receives SI through a broadcasting channel transmitted through the selected CC. Based on the received SI, the selected downlink CC and an uplink (UL) CC that has a linkage with the downlink CC is configured as a primary CC (hereinafter referred to as a ‘PCC’) or a primary serving cell (hereinafter referred to as a ‘PCell’). Through the configured PCell, a UE may transmit an RRC connection request message to an eNB. In this example, the UE may transfer the RRC connection request message to the eNB through an RACH procedure.

Here, a downlink CC corresponding to the PCell is referred to as a DL PCC, and an uplink CC corresponding to the PCell is referred to as a UL PCC.

Also, a Secondary Serving Cell (hereinafter referred to as an ‘SCell’) may be defined as an additional serving cell distinguished from the PCell, and a CC corresponding to the SCell in a downlink is referred to as a downlink secondary CC (Secondary CC; hereinafter referred to as an ‘SCC’) and a CC corresponding to the SCell in an uplink is referred to as a UL CC.

That is, a serving cell may be distinguished as a PCell and an SCell. Here, the PCell refers to a single serving cell that provides a security input and NAS mobility information in a state of an RRC establishment or re-establishment. Based on the capabilities of a UE, at least one cell is configured to form a serving cell set together with a PCell. In this example, the at least one cell corresponds to the PCell.

Therefore, a serving cell set configured for a single UE may be configured of only a single PCell, or may be configured of a single PCell and at least one SCell. An adjacent cell in a frequency of the PCell and/or an adjacent cell in a frequency of the SCell may be in the same CC frequency, and adjacent cells between frequencies of the PCell and the SCell may be in different CC frequencies.

The PCell and the SCell may have characteristics as follows.

First, the PCell may be used for PUCCH transmission.

Second, the PCell is always activated, whereas the SCell is activated or deactivated based on a predetermined condition.

Third, when the PCell experiences Radio Link Failure (hereinafter referred to as ‘RLF’), RRC re-establishment may be triggered. When the SCell experiences RLF, RRC re-establishment may not be triggered.

Fourth, the PCell may be changed by a change of a security key or by a handover procedure accompanying an RACH procedure. In a case of MSG4 (Contention resolution), only a PDCCH indicating MSG4 may be transmitted through the PCell, and MSG4 information may be transmitted through the PCell or the SCell.

Fifth, NAS information may be received through the PCell.

Sixth, the PCell may be configured as a pair of a DL PCC and a UL PCC, whereas the SCell may be configured of only a DL CC or a pair of a DL SCC and a UL SCC.

Seventh, each UE sets a different CC as the PCell.

Eighth, a procedure such as, reconfiguration, adding, or removal of the SCell may be performed by an RRC layer. To add a new SCell, an RRC signaling may be used to transmit SI associated with a dedicated SCell.

That is, according to embodiments of the present invention, a CC may be defined to be a concept including a DL CC or including both the DL CC and a UL CC, and may be defined to be a cell.

In other words, the cell may be defined by only a DL frequency resource (for example, a CC) through which a wireless signal recognized by a UE reaches a predetermined area, and may be defined to be a pair of the DL frequency resources that may be used by the UE to receive a signal from the eNB and a UL frequency resource that may be used by the UE to transmit a signal to the eNB. Therefore, the UE that configures a plurality of CCs may be described that the UE configures a plurality of serving cells.

The linkage established between a downlink CC and an uplink CC may indicate that the downlink CC and the uplink CC are connected to each other as described in the following.

1) an uplink CC through which a UE is to transmit ACK/NACK information with respect to data transmitted by an eNB through a downlink CC

2) a downlink CC through which an eNB is to transmit ACK/NACK information with respect to data transmitted by a UE through an uplink CC

3) a downlink CC that is to transmit a response when an eNB receives a RAP (Random Access Preamble) transmitted through an uplink CC by a UE that starts a Random Access Channel (RACH) procedure

4) an uplink CC to which uplink control information is applied when an eNB transmits the uplink control information through a downlink CC.

FIG. 5 is a functional block diagram illustrating a CC reconfiguring device according to an embodiment of the present invention.

The CC reconfiguring device may be embodied in a UE or embodied in conjunction with the UE.

A CC reconfiguring device 500 according to an embodiment of the present invention may be configured to include a message transmitting/receiving unit 510, a message confirmation unit 520, a CC configuration-information confirmation unit 530, a CC determination unit 540, and the like.

The CC reconfiguring device 500 generally performs functions of receiving a CC connection reconfiguration message (RRCConnectionReconfiguration) from an eNB and the like, performing a detailed CC reconfiguration procedure with respect to a corresponding UE, such as CC addition (Add), modification (Modify), release (Release), and the like, based on CC configuration information included in the message, and generating and transmitting a CC reconfiguration complete message to the eNB.

In this example, the CC configuration information may include one or more information from among CC unique information of each CC and CC index information matching the CC unique information.

The CC configuration information may include both the CC unique information and the CC index information or include one of them based on the detailed CC reconfiguration procedure. Depending on a case, another information may be additionally included in addition to the CC unique information or the CC index information.

As described in the foregoing, a CC according to embodiments of the present invention may be used as a concept equivalent to a PCell (or a PCC) or an SCell (or an SCC) or a concept including both and thus, the CC unique information may be replaced with SCell unique information and the CC index information may be replaced with SCell index information. However, for ease of description, they are expressed as CC unique information and CC index information.

Here, the CC unique information may be, for example, a constant and absolute value that distinguishes a CC in an L1 layer, and may include center frequency information of each CC, a Physical Cell Identifier (hereinafter referred to as a ‘PCI’), an Evolved Cell Global Identifier (hereinafter referred to as an ‘ECGI’), and the like, but this may not be limited thereto.

Also, the CC index information may refer to information associated with CCs that set using variable indices based on a reference CC that is determined based on priorities of CCs in an RRC layer so that the CC index information may be distinguished from CC identification information allocated to distinguish a CC in a physical layer or CC unique information.

The CC index information is, for example, a variable and relative value (for example, CC1, CC2 and the like) that is logically allocated to distinguish CCs allocated to a UE in an upper layer that is higher or equal to L2. However, the CC index information may not be limited to L2 and L3, and the form or the format may not be limited.

The CC index information refers to all types of data or information used as an indicator that matches CC unique information of each CC and distinguishes a corresponding CC. That is, the CC index information is CC indication information which is set in an RRC message, for distinguishing a CC in a physical layer.

Embodiments of the present invention define CC index information mapped to each CC using CC unique information so that a linkage may be established to distinguish a CC using only received CC index information without CC unique information.

Also, although it is desired that information distinguished from Carrier Index Field (CIF) and the like forming a PDCCH (Physical Downlink Control Channel) in an L1 layer of an LTE communication system is used as the CC index information in the embodiments of the present invention, this may not be limited thereto, and may be a concept including a case in which the CC index information is defined in another layer in addition to the L2 layer.

That is, the CC index information and the CIF may indicate the same CC using the same value. Also, the CC index information and the CIF may indicate the same CC using different values.

A function of the CC reconfiguring device according to an embodiment of the present invention will be described in detail.

The message transmitting/receiving unit 510 receives an RRC connection reconfiguration message transmitted by the eNB and the like, and performs CC reconfiguration and transmits an RRC connection reconfiguration complete message to the eNB and the like.

The message confirmation unit 520 performs a function of determining a type of a message received by the message transmitting/receiving unit, and particularly, performs a function of determining whether the received message is an RRC connection reconfiguration message, a function of determining whether the received RRC connection reconfiguration message is an RRC connection reconfiguration message received first after an RRC connection re-establishment procedure, a function of determining whether information indicating full configuration is included in the RRC connection reconfiguration message, a function of determining whether a radio resource configuration dedicated message is included in the RRC connection reconfiguration message, a function of determining whether another reconfiguration structure information is included in the RRC connection reconfiguration message in addition to the radio resource configuration dedicated message, and the like.

Also, according to embodiments of the present invention, the message confirmation unit 520 performs a function of determining whether the message received by the message transmitting/receiving unit 510 corresponds to at least one of CC addition, CC modification, and CC release. The message confirmation unit 520 performs all the described functions or may selectively perform at least one of the functions depending on cases.

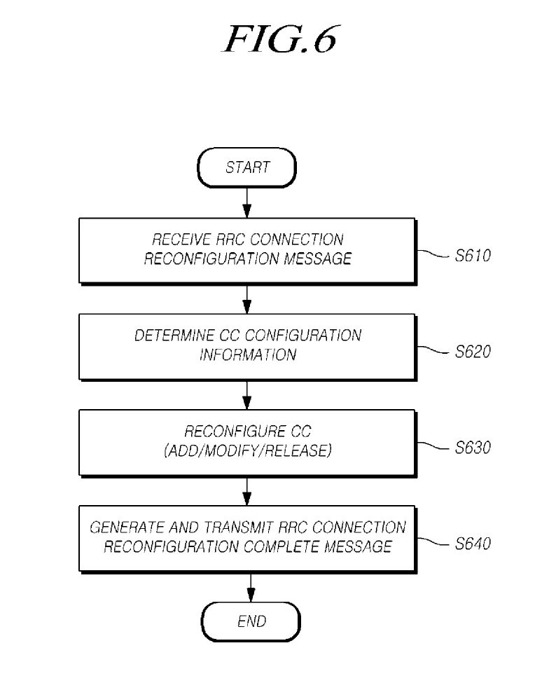

A type of the message determined by the message confirmation unit 520 may be transferred to the CC configuration-information confirmation unit 530 or the CC determination unit 530, and may be used for a CC reconfiguration procedure. Here, the CC reconfiguration procedure will be described in detail with reference to FIGS. 6 through 8.

The CC configuration-information confirmation unit 530 may perform a function of determining whether CC configuration information is included in the radio resource configuration dedicated message, that is, a function of determining whether the CC configuration information is for at least one of the CC addition, the CC modification, and the CC release.

Here, the CC configuration information may include CC unique information including center frequency information of each CC and PCI or ECGI and the like, and/or CC index information, and may additionally include another information in addition to the CC unique information or the CC index information.

When it is determined that the CC configuration information corresponds to one of the CC addition, the CC modification, and the CC release, the CC determination unit 540 performs a reconfiguration procedure with respect to a corresponding CC.

That is, CC determination unit 540 performs 1) mapping of CC index information to a corresponding CC using CC index information and CC unique information included in the CC configuration information when the CC configuration information is transmitted for adding the corresponding CC, 2) updating corresponding CC information or changing mapping information between CC index information of each CC that is previously configured and a corresponding CC based on whether SI update notification exists in a case of CC modification (Modify), and 3)releasing a corresponding CC based on existing CC index information included in the CC configuration information in a case of CC release (Release).

A CC reconfiguration procedure of each of the CC addition, the CC modification, and the CC release will be described in detail with reference to FIGS. 6 through 8.

When the CC reconfiguration procedure of the CC determination unit 540 is completed, the CC reconfiguring device 500 generates an RRC connection reconfiguration complete message and transmits the generated message to the eNB and the like through the message transmitting/receiving unit 520.

The other information included in the CC configuration information in addition to the CC unique information or the CC index information may be physical channel configuration information, and the physical channel configuration information may be information associated with a downlink or an uplink, or information associated with both, including following examples, but this may not be limited thereto.

1) Information (radioResourceConfigCommonDL) commonly applied to a downlink with respect to all UEs that configure a corresponding CC from among information associated with a physical data channel that an eNB transmits to a UE, a physical HARQ determining channel, antenna-related information, and the like

2) Information (radioResourceConfigCommonUL) commonly applied to an uplink with respect to all UEs that configure a corresponding CC from among information associated with a physical control channel that a UE transmits to an eNB, a physical data channel, a sounding reference signal, an uplink CP (cyclic prefix) length, and the like

3) Configuration information (pdsch-ConfigDedicated) associated with a physical data channel that an eNB transmits to a corresponding UE

4) Configuration information (pdcch-ConfigDedicated) associated with a physical control channel that an eNB transmits to a corresponding UE

5) Configuration information (pusch-ConfigDedicated) associated with a physical data channel that a corresponding UE transmits to an eNB

6) Basic information (uplinkPowerControlDedicated) for controlling transmission power transmitted by a corresponding UE

7) Transmission power control information (tpc-PDCCH-ConfigPUSCH) associated with a physical data channel transmitted by a corresponding UE

8) Transmission power control information (tpc-PDCCH-ConfigPUCCH) associated with a physical control channel transmitted by a corresponding UE

9) Information (cqi-ReportConfig) associated with a configuration of channel quality information that a corresponding UE transmits to an eNB

10) Configuration information (soundingRS-UL-ConfigDedicated) associated with a sounding reference signal that a corresponding UE transmits to an eNB

11) Information (antennaInfoDL) associated with an antenna that is used when an eNB transmits a signal to a corresponding UE

The information of 11) may correspond to the following information a) and information b).
a) Transmission mode (hereinafter referred to as ‘TM’) information based on a MIMO (multiple input multiple output; hereinafter referred to as an MIMO) scheme such as a spatial multiplexing that an eNB uses, spatial diversity scheme, or the like
b) additional information associated with an MIMO scheme that is used by a predetermined TM (for example, information associated with limitations of the use of a codebook based on a spatial multiplexing TM scheme that uses a codebook based precoding)

12) information (antennaInfoUL) associated with an antenna that a corresponding UE transmits a signal to an eNB

The information of 12) may correspond to the following information a) through information c)
a) TM information based on a spatial multiplexing that a UE uses, a spatial diversity scheme, or the like
b) additional information associated with an MIMO scheme that a predetermined TM uses
c) transmission antenna selection information of a UE

13) Physical channel configuration information (schedulingRequestConfig) associated with scheduling request information that a corresponding UE transmits an eNB

The information 3) through the information 13) from among the physical channel configuration information may be information applied to only a predetermined UE

One or more of the physical configuration information that may be included in the CC configuration information may be structured and may be configured as shown in Table 1.

TABLE 1
CC-PhysicalConfigDL ::= SEQUENCE {

| radioResourceConfigCommonDL | RadioResourceConfigCommonDL | OPTIONAL, | -- Need ON |
|---|---|---|---|
| pdsch-ConfigDedicated | PDSCH-ConfigDedicated | OPTIONAL, | -- Need ON |
| antennaInfoDL | CHOICE { | | |
| explicitValue | AntennaInfoDedicatedDL, | | |
| defaultValue | NULL | | |
| } OPTIONAL, | | | -- Need ON |

CC-PhysicalCOnfigUL ::= SEQUENCE {

| radioResourceConfigCommonUL | RadioResourceConfigCommonUL | OPTIONAL, | -- Need ON |
|---|---|---|---|
| pucch-ConfigDedicated | PUCCH-ConfigDedicated | OPTIONAL, | -- Need ON |
| pusch-ConfigDedicated | PUSCH-ConfigDedicated | OPTIONAL, | -- Need ON |
| uplinkPowerControlDedicated | UplinkPowerControlDedicated | OPTIONAL, | -- Need ON |
| tpc-PDCCH-ConfigPUCCH | TPC-PDCCH-Config | OPTIONAL, | -- Need ON |
| tpc-PDCCH-ConfigPUSCH | TPC-PDCCH-Config | OPTIONAL, | -- Need ON |
| cqi-ReportConfig | CQI-ReportConfig | OPTIONAL, | -- Need ON |
| soundingRS-UL-ConfigDedicated | SoundingRS-UL-ConfigDedicated | OPTIONAL, | -- Need ON |
| antennaInfoUL CHOICE { | | | |
| explicitValue | AntennaInfoDedicatedUL, | | |
| defaultValue | NULL | | |
| schedulingRequestConfig | SchedulingRequestConfig | OPTIONAL, | -- Need ON |
| } OPTIONAL, | | | -- Need ON |
| ..., | | | |

As shown in Table 1, information for configuring a DL CC may be included in CC-PhysicalConfigDL and information for configuring a UL CC may be distinctively defined to be CC-PhysicalConfigUL. In a case of each configuration information (for example, pdsch-ConfigDedicated, pucch-configDedicated, or the like) included in CC configuration information (CC-PhysicalConfigDL and CC-PhysicalConfigUL) that is transmitted through an RRC connection reconfiguration message that is different from an initial RRC connection reconfiguration message (RRCConnectionReconfiguration), only an item that needs to be modified by an eNB may be transmitted. Therefore, a UE performs modification based on only received CC configuration information, and may not release an item that is not received and may maintain previously received parameter values.

Also, each of uplink CC configuration information and downlink CC configuration information in each SCell may be distinctively handled. For example, when CC configuration information in an RRC connection reconfiguration message (RRCConnectionReconfiguration) that is received first may include uplink CC configuration information and downlink CC configuration information, and CC configuration information in an RRC connection reconfiguration message (RRCConnectionReconfiguration) that is subsequently received may not include uplink CC configuration information, a downlink CC configuration may be modified based on information in a reconfiguration message and only an uplink CC configuration may be continuously maintained.

Also, according to another embodiment of the present invention, the downlink CC configuration may be modified based on information in a reconfiguration message and the uplink CC may be released.

When CC configuration information in an RRC connection reconfiguration message (RRCConnectionReconfiguration) does not include downlink CC configuration information (CC-PhysicalConfigDL), a UE determines the message to be a wrong message irrespective of existence of uplink CC configuration information (CC-PhysicalConfigUL), and disregards contents of corresponding CC configuration information.

A name and meaning of a field used for CC configuration information according to an embodiment of the present invention may be as shown in the following table, but this may not be limited thereto. The name and meaning of the field may be expressed by another name or term, may be configured by integrating one or more fields or may be configured by dividing a single field into two or more fields. The CC configuration information may be transmitted to a UE through an RRC message.

Table 2 illustrates an example of a configuration of an RRC connection reconfiguration message according to embodiments of the present invention.

TABLE 2
-- ASN I START

| ComponentCarrierConfig ::= | SEQUENCE { | | |
|---|---|---|---|
| cc-ToAddList | CC-ToAddList | OPTIONAL, | -- Cond HO-toEUTRA |
| cc-ToModList | CC-ToModList | OPTIONAL, | -- Cond HO-toEUTRA |
| cc-IndexReconfigList | CC-IndexReconfigList | OPTIONAL, | -- Need ON |
| cc-ToReleaseList | CC-ToReleaseList | OPTIONAL | -- Need ON |
| ..., | | | |
| } | | | |

| | |
|---|---|
| CC-ToAddList ::= | SEQUENCE (SIZE (I..maxCC)) OF CC-ToAdd |

CC-ToAdd ::= SEQUENCE {

| | | | |
|---|---|---|---|
| cc-Index | CC-Index | OPTIONAL, | -- Cond CCtoAddDL |
| targetPhysCellId | PhysCellId | OPTIONAL, | -- Cond CCtoAddDL |
| dl-CarrierFreq | ARFCN-ValueEUTRA | OPTIONAL, | -- Cond CCtoAddUL |
| ul-CarrierFreq | ARFCN-ValueEUTRA | OPTIONAL, | -- Cond CCtoAddUL |
| CC-physicalConfigDL | PhysicalConfigDL | OPTIONAL, | -- Cond CCtoAddDL |
| CC-physicalConfigUL | PhysicalConfigUL | OPTIONAL, | -- Cond CCtoAddUL |
| pCC | BOOLEAN | OPTIONAL, | -- Need ON |
| ... | | | |
| } | | | |

| | |
|---|---|
| CC-ToModList ::= | SEQUENCE (SIZE (I..maxCC)) OF CC-ToMod |

CC-ToMod ::= SEQUENCE {

| cc-Index | CC-Index, | | |
|---|---|---|---|
| SI-UpdateNotification | {0,1,2} | OPTIONAL, | -- Cond Slupdate |
| CC-newIndex | CC-Index, | OPTIONAL, | -- Cond CCtoMod |
| CC-physicalConfigDL | PhysicalConfigDL | OPTIONAL, | -- Cond Siupdate |
| CC-physicalConfigUL | PhysicalConfigUL | OPTIONAL, | -- Cond Siupdate |
| CC-physicalConfigDL | PhysicalConfigDedicated DL | OPTIONAL,-- Cond CctoModDL | |
| CC-physicalConfigUL | PhysicalConfigDedicatedUL | OPTIONAL,-- Cond CctoModUL | |
| ... | | | |
| } | | | |

| | |
|---|---|
| CC-IndexReconfigList ::= | SEQUENCE (SIZE (I..maxCC)) OF CC-IndexReconfig |

CC-IndexReconfig ::= SEQUENCE {

| CC-Index | CC-Index |
|---|---|
| PhysCellId | PhysCellId |
| dl-CarrierFreq | ARFCN-ValueEUTRA |
| ul-CarrierFreq | ARFCN-ValueEUTRA |
| } | |
| CC-ToReleaseList ::= | SEQUENCE (SIZE (I..maxCC)) OF CC-Index |
| -- ASN I STOP | |

Although definitions of a few fields or a few items shown in Table 2 are described as shown in Table 3, used terms of the few fields may not be limited to the descriptions of Table 3 since the same definition may be described using another field.

TABLE 3

| Item | Meaning |
|---|---|
| ComponentCarrierConfig | CC configuration information |
| cc-ToAddList | A list of CCs to be added |
| cc-ToModList | A list of CCs to be modified |
| cc-ToReleaseList | A list of CCs to be released |
| CC-IndexReconfigList | A list of CCs of which only cc index values are |
| | to be re-mapped |
| CC-ToAdd | Configuration information associated with |
| | parameters required for adding a CC to be added |
| CC-ToMod | Configuration information associated with |
| | parameters required for modifying a CC to be |
| | modified |
| cc-Index | An index value of a corresponding CC |
| CC-PhysCellId | A PCI value allocated to a corresponding CC |
| | the PCT value may be allocated based on an |
| | eNB unit. Also, different PCIs may be |
| | allocated based on a sector unit in the same |
| | eNB. Therefore, CCs in the same eNB or the |
| | same sector may be set to the same PCI value. |
| dl-CarrierFreq | A center frequency value of a downlink |
| | component carrier |
| ul-CarrierFrq | A center frequency value of an uplink |
| | component carrier |
| CC-physicalConfigDL | Downlink physical channel configuration |
| | information |
| CC-physicalConfigUL | Uplink physical channel configuration |
| | information |
| pCC | An indicator indicating a primary CC (PCC) |
| SI-UpdateNotification | An indicator indicating whether SI update is |
| | performed |
| | 0: no SI update and that a corresponding CC is |
| | a PCC |
| | 1: no SI update and that a corresponding CC is |
| | an SCC |
| | 2: SI update and that a corresponding CC is an |
| | SCC |
| CC-newIndex | A CC index value to be changed |

Meaning of ‘Mandatory’ or ‘Optional’ with respect to each field or item in Table 1 through Table 3 may be defined as shown in Table 4.

TABLE 4

| Abbreviation | Meaning |
|---|---|
| Cond | Conditionally present |
| condition Tag | An information element for which the need is specified by |
| | means of conditions. For each condition Tag, the need is |
| | specified in a tabular form following the ASN. 1 segment. |
| | In case, according to the conditions, a field is not present, the |
| | UE takes no action and where applicable shall continue to |
| | use the existing value (and/or the associated functionality) |
| | unless explicitly stated otherwise in the description of the |
| | field itself. |
| Need OP | Optionally present |
| | An information element that is optional to signal. For |
| | downlink messages, the UE is not required to take any |
| | special action on absence of the IE beyond what is specified |
| | in the procedural text or the field description table following |
| | the ASN.1 segment. The UE behaviour on absence should |
| | be captured either in the procedural text or in the field |
| | description. |
| Need ON | Optionally present, No action |
| | An information element that is optional to signal. If the |
| | message is received by the UE, and in case the information |
| | element is absent, the UE takes no action and where |
| | applicable shall continue to use the existing value (and/or the |
| | associated functionality). |
| Need OR | Optionally present, Release |
| | An information element that is optional to signal. If the |
| | message is received by the UE, and in case the information |
| | element is absent, the UE shall discontinue/stop using/delete |
| | any existing value (and/or the associated functionality). |

In the table, ‘Mandatory’ indicates a necessarily required message when an RRC connection reconfiguration message is transmitted for a predetermined purpose (for example, a handover, CC addition, CC modification, CC release, and the like). ‘Optional’ indicates that information may be added when reconfiguration with respect to corresponding information is required, and information may not be included when the reconfiguration is not required. When ‘Optional’ is not specified, it is regarded as a case of ‘Mandatory’.

Also, definitions of conditions specified in Table 1 through Table 3 may be as shown in Table 5.

TABLE 5

| Condition | Meaning |
|---|---|
| CC-AddDL | The field is mandatory present if the corresponding DL |
| | CC is being added (including CC setup at handover |
| | within E-UTRA and to E-UTRA) otherwise it is not |
| | present. |
| CC-AddUL | The field is mandatory present if the corresponding UL |
| | CC is being added (including CC setup at handover |
| | within E-UTRA and to E-UTRA) otherwise it is not |
| | present. |
| CC-ModDL | The field is mandatory present if the corresponding DL |
| | CC is being modified and if the corresponding DL SCC |
| | is updating SI otherwise it is not present. |
| CC-ModUL | The field is mandatory present if the corresponding UL |
| | CC is being modified and if the corresponding UL SCC |
| | is updating SI otherwise it is not present. |
| SIupdate | The field is mandatory present in case of SI update on |
| | SCC in case of RRC connection establishment and RRC |
| | connection re-establishment the field is not present; |
| | otherwise the field is optionally present, need ON. |

FIG. 6 is a flowchart illustrating a CC reconfiguration method according to an embodiment of the present invention.

The CC reconfiguration method according to an embodiment of the present invention may be performed in a UE, but this may not be limited thereto and the CC reconfiguration method may be performed in other devices and the like.

The CC reconfiguration method according to an embodiment of the present invention briefly includes a step of receiving an RRC connection reconfiguration message in step S610, a step of determining CC configuration information included in the RRC connection reconfiguration message in step S620, a step of performing CC reconfiguration by performing CC addition, CC modification, and CC release based on the determined CC configuration information in step S630, and a step of generating and transmitting an RRC connection reconfiguration complete message to an eNB and the like in step S640. Here, the CC addition, the CC modification, and the CC release may be performed by checking a list including at least one CC for performing a corresponding process.

For example, when CC-ToModList is checked from the RRC connection reconfiguration message, SEQUENCE (SIZE (1 . . . maxCC)) OF CC-ToMod is determined. Here, maxCC indicates a total number of CCs allocated to a UE. Therefore, a number of modifiable CCs may be all the CCs allocated to the UE. That is, all the CCs of the UE may be modified through a single RRC connection reconfiguration message.

In step S610 of receiving the RRC connection reconfiguration message, a message transmitted from the eNB and the like is received, and whether the received message is an RRC connection reconfiguration message is determined or whether the received RRC connection reconfiguration message is an RRC connection reconfiguration message received first after an RRC connection re-establishment procedure may be additionally performed.

In step S620 of determining the CC configuration information included in the RRC connection reconfiguration message, whether CC configuration information is included in the RRC connection reconfiguration message, particularly, in a radio resource configuration dedicated message, may be determined, and whether the included CC configuration information corresponds to at least one of CC addition, CC modification, and CC release may be determined.

A detailed configuration of step S630 of performing CC addition, CC modification, and CC release of a corresponding CC based on the determined CC configuration information will be omitted since the configuration is the same as the CC determination unit 540 of FIG. 5.

In step S640 of generating and transmitting the RRC connection reconfiguration complete message to the eNB and the like, an RRC connection reconfiguration complete message for reporting the completion of CC reconfiguration after CC reconfiguration is completed may be generated and transmitted to the eNB.

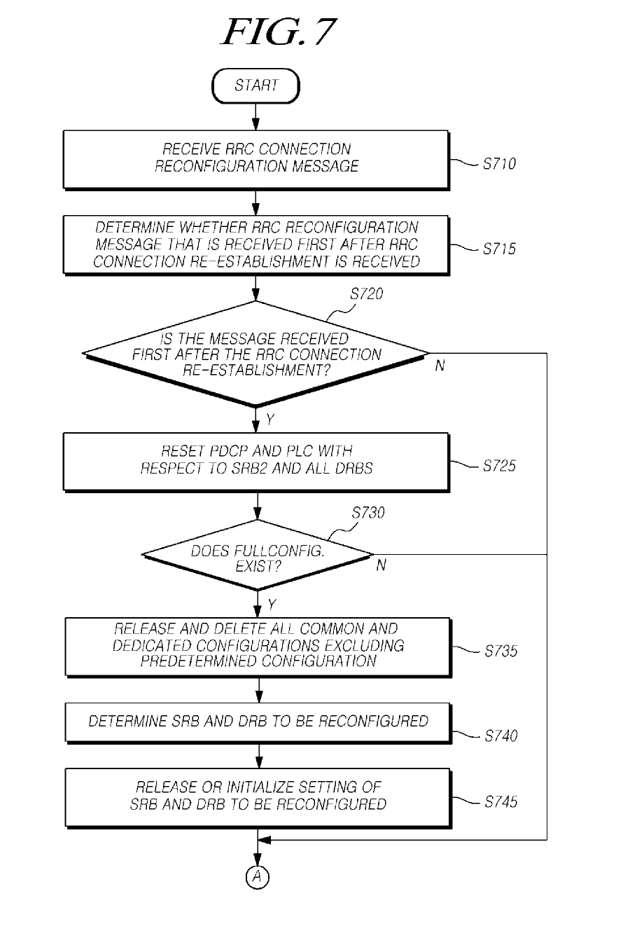

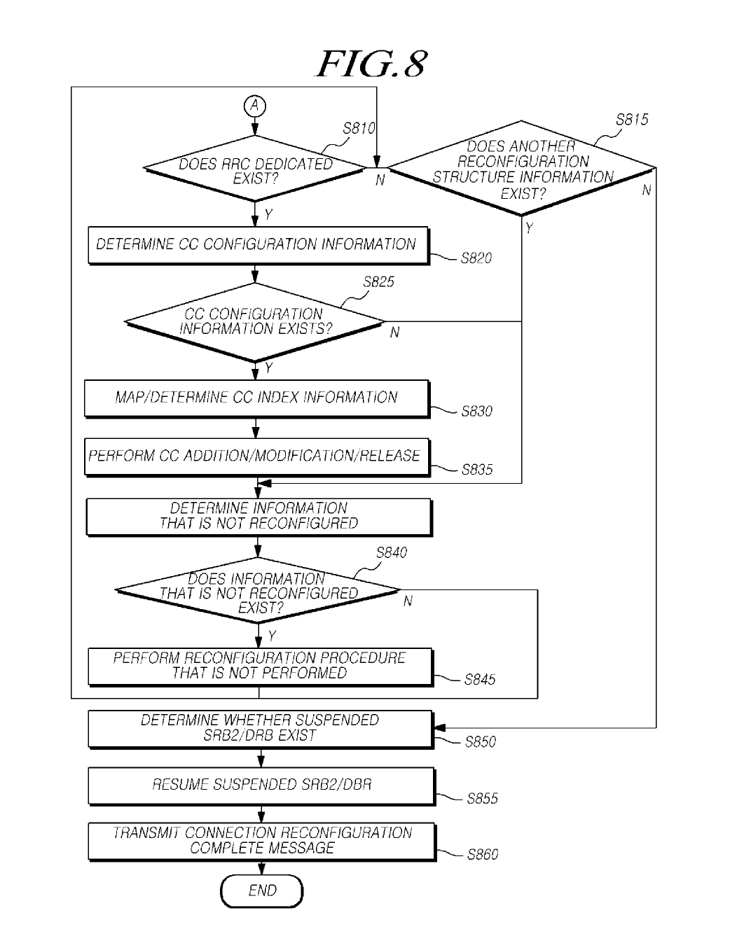

FIGS. 7 and 8 are diagrams illustrating a CC reconfiguration process according to an embodiment of the present invention in detail.

Referring to FIG. 7, a UE or a CC reconfiguring device receives an RRC connection reconfiguration message transmitted from an eNB in step S710.

Subsequently, the UE determines whether the received RRC connection reconfiguration message is an RRC connection reconfiguration message received first after an RRC connection re-establishment procedure in step S715. When the received message corresponds to the RRC reconfiguration message received first after the RRC connection re-establishment procedure, operations corresponding to step S720 and the subsequent steps may be performed. Otherwise, step S720 and the subsequent steps may not be performed, and step S810 of FIG. 8 may be performed.

When the RRC connection reconfiguration message corresponds to the RRC connection reconfiguration message received first after the RRC connection re-establishment procedure in step S620, a Packet Data Convergence Protocol (PDCP) and a Radio Link Control (RLC) may be reset with respect to an existing signaling radio bearer (Signaling Radio Bearer; hereinafter referred to as an ‘SRB’) and all set data radio bearers (Data Radio Bearer; hereinafter referred to as a ‘DRB’) in step S725.

Here, the SRB refers to a Radio Bearer (hereinafter referred to as an ‘RB’) used for transmitting RRC and NAS messages, and the DRB refers to an RB used for transmitting all information excluding messages transmitted through the SRB.

The SRB is classified into three types, including SRB0, SRB1, and SRB2.

First, the SRB0 is used for an RRC message that uses a CCCH (common control channel) logical channel. A downlink CCCH is used for transmitting information associated with RRC connection establishment, connection re-establishment, refusal of connection establishment, and refusal of connection re-establishment, and an uplink CCCH is used for transmitting information associated with an RRC connection request and an RRC connection re-establishment request.

Also, the SRB1 is used for all RRC messages that use a DCCH logical channel. An NAS message is partially included in the RRC message. Also, the SRB1 is used for NAS messages before the SRB2 is set. In this example, an added downlink NAS message may be used for only a procedure performed with an RB setting/modifying/and releasing procedures, and an added uplink NAS message is used for only transmitting an initial NAS Message during RRC connection establishment.

Also, the downlink DCCH is used for transmitting information associated with RRC connection reconfiguration and connection release, and is used for transmitting information associated with Security Mode command, counter check, and a handover between different networks, is used for transmitting information associated with a downlink, and is used for transmitting information associated with a UE information request and UE capability enquiry.

The uplink DCCH is used for transmitting information associated with completion of RRC connection reconfiguration, completion of connection re-establishment, and completion of connection establishment, and is used for transmitting information associated with completion of security mode setup or failure of security mode setup, a counter check response, and proximity indication, is used for transmitting information associated with an uplink, and is used for transmitting information associated with a measurement report, a UE information response, and UE capability information.

Next, the SRB2 is used for NAS messages that use a DCCH logical channel. The SRB2 has a lower priority than the SRB1, and is always configured by E-UTRAN after security is activated. That is, security setup is completed after RRC connection establishment is completed and the SRB2 may be configured through an RRC connection reconfiguration procedure.

Subsequently, the UE determines whether information indicating full configuration is included in the RRC connection reconfiguration message in step S730.

When the information indicating the full configuration is included in the RRC connection reconfiguration message, operations corresponding to step S735 and the subsequent steps may be performed. Otherwise, steps S735 through S745 may not be performed and step S810 of FIG. 8 may be performed.

When the information indicating the full configuration is included in the RRC connection reconfiguration message, a configuration for only a corresponding UE and all common configurations excluding a predetermined configuration may be released or deleted in step S735.

Here, the predetermined configuration includes a configuration associated with security, and includes a PDCP, an RLC, and a logical channel configuration with respect to an RB.

Subsequently, whether an SRB or DRB to be reconfigured exists is determined in step S740. When an SRB to be added or modified exists, an RLC configuration may be initialized based on a type of each SRB, and a logical channel may be initialized based on a type of each SRB.

Also, when a DRB to be added or modified exists, a value of an eps-bearer identity (Enhanced Packet System-Bearer Identity) in each DRB configuration information is determined and related settings may be released in step S745.

In particular, when the determined eps-bearer identity is a portion of a current UE configuration, a PDCP entity, an RLC entity, a DTCH logical channel, and a drb-ID (drb-identity) of a corresponding DRB are released.

Also, when a DRB is not a DRB to be added or modified but an eps-bearer identity of the DRB is a portion of a current corresponding UE configuration, a corresponding DRB configuration is released.

FIG. 8 illustrates a CC reconfiguration process performed after the process of FIG. 7. After step S745, the UE or the CC reconfiguring device determines whether a radio resource configuration dedicated message exists in the RRC connection reconfiguration message in step S810.

When the radio resource configuration dedicated message does not exist in the RRC connection reconfiguration message, whether another reconfiguration structure information exists may be determined in step S815.

Here, the reconfiguration structure information refers to information structured through classification based on a purpose to be achieved through an RRC reconfiguration message.

For example, when an eNB transmits an RRC reconfiguration message for measurement control with respect to a predetermined UE, the corresponding UE may determine whether reconfiguration structure information exists.

After steps S810 and 815, the UE determines whether CC configuration information exists in the radio resource configuration dedicated message in step S820, which is the same as shown in Table 3.

When the CC configuration information exists in step S825, a mapping relationship between CC index information and CC unique information of each CC included in the CC configuration information is determined so that a procedure the CC configuration information corresponds to from among CC addition, CC modification, and CC release is determined in step S830.

A process of determining a procedure the CC configuration information corresponds to from among the CC addition and the CC modification in step S830 may be described as follows. For example, when cc-ToAddList exists in ComponentCarrierConfig from among fields of Table 3, it is determined that information associated with CC addition is included. When cc-IndexReconfigList or cc-ToModList exists in ComponentCarrierConfig, it is determined that information associated with CC modification is included.

However, this may not be limited to the process, and a procedure the CC configuration information corresponds to from among the CC addition/modification/release may be determined using another scheme.

Also, the CC configuration information may include physical channel configuration information associated with a downlink or an uplink, or physical channel configuration information associated with both the downlink and the uplink, and the example thereof has been described with reference to FIG. 5.

In step S835, one or more processes from among CC addition, CC modification, and CC release of a corresponding CC, that is, a CC reconfiguration process, may be performed based on the CC configuration information.

The CC reconfiguration process of step S835 will be described in detail as follows.

When the CC configuration information is transmitted to add a corresponding CC, the UE may map CC index information to a corresponding CC using the CC index information and CC unique information included in the CC configuration information.

As described in the foregoing, in this example, the CC unique information is a constant and absolute value that distinguishes a CC in L1 and the like, and may include center frequency information of each CC, PCI, ECGI, and the like. The CC index information is a variable and relative value (for example, CC1, CC2, and the like) that is logically allocated to distinguish CCs allocated to the UE in an upper layer higher than or equal to L2.

For example, cell-specific CIF values may be set based on a method of setting CIF values with respect to all CCs allocable from the eNB to the UE based on a center frequency value of each CC in ascending order. Also, UE-specific CIF values may be set based on a method of setting CIF values with respect to all CCs that are currently allocated from the eNB to is the UE based on a center frequency value of each CC in ascending order. CC index information of L2 or a higher layer may be set in the same manner as the setting of the CIF in the PDCCH, or CC index information may be set based on a different CC distinguishing scheme from the setting of the CIF of the PDCCH, as necessary.

Here, the different CC distinguishing scheme corresponds to a scheme of allocating identification information to distinguish a CC based on a characteristic of a CC based on an RRC message since the corresponding CC needs to be distinguished in association with transmission of the RRC message in the L2 or higher layer. For example, a PCC is set to a reference CC and 1 is assigned to the PCC, and 2, 3, . . . , and N may be assigned to CCs in order of closest distance to a center frequency based on the PCC. In this manner, CC identification information may be assigned.

Therefore, the different CC distinguishing scheme may provide a degree of flexibility to setting of CC index in an upper level and thus, CC index rearrangement performed in an upper signaling for distinguishing CCs may not need to be performed. That is, the upper signaling may be optimized based on the CC index rearrangement. Based on the above reason, an unnecessary signaling of an upper level message may be reduced.

That is, CC addition establishes a linkage between a corresponding CC and a CC index value so that the corresponding CC is distinguished based on only received CC index information without CC unique information.

The CC unique information may include PCI value/ECGI value of each CC, and a center frequency value of each CC, but this may not be limited thereto.

When the CC configuration information is transmitted to modify a corresponding CC, a list of CCs to be modified is determined and whether the corresponding CC is included is determined.

The CC modification procedure may be briefly classified as a modification of a CC and a modification of mapping information between a CC index and a CC.

Also, the modification of a CC in the CC modification procedure may be classified into 4 types, which will be described in detail as follows.

A first type of the modification of a CC corresponds to a case in which a CC to be modified is information associated with a PCC, that is, a case in which an SI update notification value is 0 (please refer to Table 3).

In this example, although parameters associated with SI exist from among variable parameters of the PCC of a corresponding UE, only modified CC configuration information that may not be received through the SI is included in CC configuration information. In this example, modified SI associated with the PCC may be received through a broadcasting channel as opposed to an RRC message.

A second type of the modification of a CC corresponds to a case in which SI update notification information is included in the CC configuration information, that is, a case in which an SI update notification value is 1 (please refer to Table 3).

In this example, all existing CC configuration information excluding information associated with a CC index (CC index, CC-new index, and the like) may be removed or released, or may be set to a default value, and CC configuration information of a corresponding CC may be set based on the received modified CC configuration information.

A third type of the modification of a CC corresponds to a case in which SI update notification information is excluded (that is, an SI update notification value is 2) and new CC index information (CC-new Index information) is included (please refer to Table 3).

In this example, the UE re-maps the new CC index information to a corresponding CC based on existing CC index information or CC unique information included in the CC configuration information, and updates corresponding CC information.

A fourth type of the modification of a CC corresponds to a case in which SI update notification information is excluded (that is, an SI update notification value is 2), and new CC index information is excluded (please refer to Table 3).

In this example, CC information may be updated based on the received CC configuration information. Remaining CC information may be continuously maintained.

The modification of mapping information between a CC index and a CC in the CC modification procedure corresponds to a case in which CC configuration information is transmitted to modify mapping information between CC index information and a CC for each CC that is currently configured for the UE. The UE re-maps each CC index information based on existing CC index information included in the CC configuration information and CC index information associated with CCs to be modified. In this example, a range of remapping of a CC index may include a downlink CC and an uplink CC.

In this example, through the CC index remapping, CC index mapping of a downlink CC may not be modified and only CC index mapping of an uplink CC may be modified. Conversely, the CC index mapping of the downlink CC may be modified and the CC index mapping of the uplink CC may not be modified, or both the downlink and the uplink may be modified.

Lastly, when the CC configuration information is transmitted to release a corresponding CC, the UE releases a CC index from the corresponding CC using CC index information and CC unique information included in the CC configuration information. THE CC unique information includes only an existing CC index value of the corresponding CC.

In this example, the CC configuration may be embodied based on the configuration illustrated in Table 1 through Table 5, but this may not be limited thereto.

Upon completion of the CC reconfiguration process of step S835, the UE determines information included in the radio resource configuration dedicated message so as to determine whether information that is not reconfigured exists in step S840, and proceeds with a reconfiguration procedure that is not performed when information that is not reconfigured exists in step S845.

Also, when all the reconfiguration associated with the radio resource configuration dedicated message is completed, whether another reconfiguration structure information exists in RRC connection reconfiguration is determined, and a reconfiguration is procedure may be performed based on a corresponding procedure when structure information that is not reconfigured exists.

Subsequently, when all the RRC connection reconfiguration is completed, the UE determines whether an SRB2 and a DRB, which were suspended, exist is determined in step S850, and the UE resumes the SRB2 and the DRB, which were suspended, when the SRB2 and the DRB exist in step S855.

When the RRC connection reconfiguration process is completed through all the processes, the UE generates an RRC connection reconfiguration complete message and transmits the RRC connection reconfiguration complete message to the eNB in step S860.

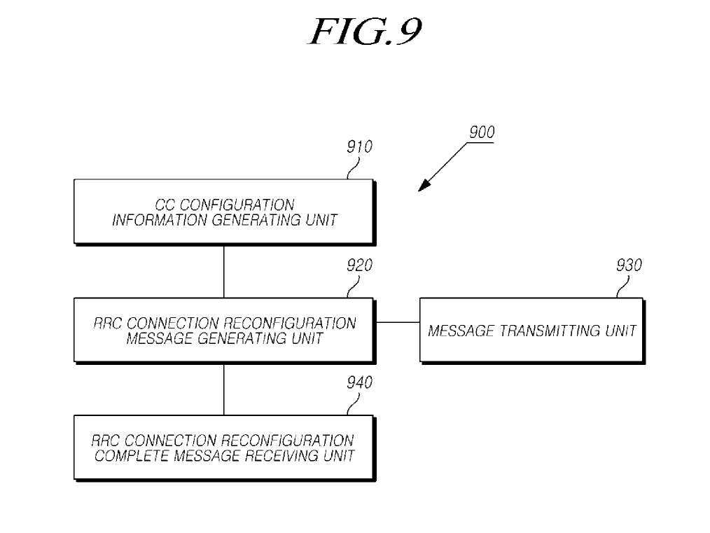

FIG. 9 is a functional block diagram illustrating an RRC connection reconfiguration message transmitting device according to an embodiment of the present invention.

An RRC connection reconfiguration message transmitting device 900 according to an embodiment of the present invention is configured to include a CC configuration information generating unit 910, an RRC connection reconfiguration message generating unit 920, a message transmitting unit 930, and an RRC connection reconfiguration complete message receiving unit 940.

The RRC connection reconfiguration message transmitting device 900 may be embodied in an eNB or may be embodied in conjunction with the eNB.

The CC configuration information generating unit 910 according to an embodiment of the present invention may generate, for each CC, CC configuration information to include one or more information from among CC unique information and CC index information matching the CC unique information. The CC configuration information may be generated to include both the CC unique information and the CC index information, or to include one of the information or to include additional physical channel configuration information in addition to the information, based on a detailed CC reconfiguration procedure.

Also, the CC configuration information generating unit 910 may generate the CC configuration information to include information indicating a detailed CC reconfiguration form, that is, at least one of CC addition, CC modification, and CC release.

In this example, the CC unique information is a constant and absolute value that distinguishes a CC in L1 and the like, and may include center frequency information of each CC, a PCI and/or ECGI value, and the like, as described in the foregoing.

It is desired that a variable and relative value (for example, CC1, CC2, and the like) that is logically allocated to distinguish CCs allocated to a UE(UE) in an upper layer higher than or equal to L2 is used as the CC index information, but this may not be limited to L2 and L3 and the form or the format may not be limited. The CC index information may indicate all types of data or information used as an indicator that matches CC unique information of each CC and distinguishes a corresponding CC.

The RRC connection reconfiguration message generating unit 920 generates an RRC connection reconfiguration message to include the CC configuration information generated by the CC configuration information generating unit 810, and the RRC connection reconfiguration message may include one or more information from among information indicating full configuration, information indicating a radio resource configuration dedicated message, and another reconfiguration structure information in addition to the radio resource configuration dedicated message.

The message transmitting unit 930 performs a function of transmitting the generated RRC connection reconfiguration message to a UE and the like.

The UE performs one or more CC reconfiguration processes from among CC addition, CC modification, and CC release based on the CC configuration information included in the RRC connection reconfiguration message that is transmitted by the RRC connection reconfiguration message transmitting device, and generates and transmits an RRC connection reconfiguration complete message.

The CC reconfiguration process of the UE has been described in the foregoing and thus, detailed descriptions thereof will be omitted.

The RRC connection reconfiguration complete message receiving unit 940 may receive the RRC connection reconfiguration complete message transmitted by the UE or the CC reconfiguration device.

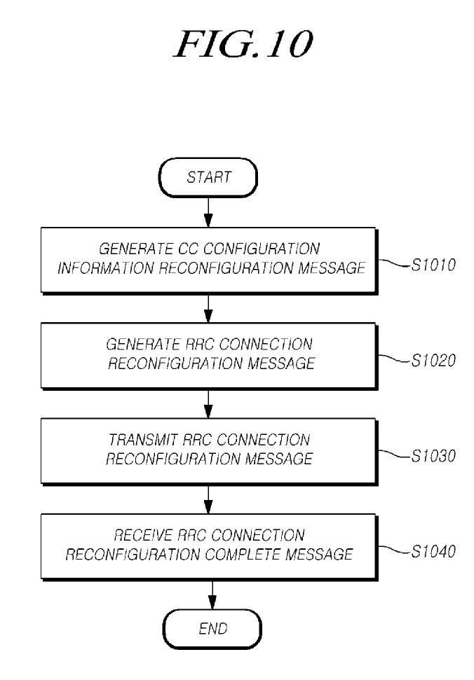

FIG. 10 is a flowchart illustrating an RRC connection reconfiguration message transmitting method according to an embodiment of the present invention.

The RRC connection reconfiguration message transmitting method according to an embodiment of the present invention may be configured to include a CC configuration information generating step S1010, an RRC connection reconfiguration message generating step S1020, an RRC connection reconfiguration message transmitting step S1030, and an RRC connection reconfiguration complete message receiving step S1040.

A process of each step, CC unique information, CC index information, and physical channel configuration information, and the like may be embodied in the same manner as described in the foregoing and thus, detailed descriptions thereof will be omitted to avoid redundancy.

According to an embodiment of the present invention, when reconfiguration is required for a few of the CCs allocated to a UE in a communication system that uses multiple CCs, an effective CC reconfiguration process may be performed by utilizing CC configuration information or an RRC connection reconfiguration message for the reconfiguration.

Also, CC index information mapped to each CC using corresponding CC unique information may be defined so that a linkage may be established to distinguish a CC based on only received CC index information without CC unique information, and the CC index to information may be utilized in CC a reconfiguration process.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present is invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

1. A Component Carrier (CC) reconfiguring device of a User Equipment (UE) in a communication system that uses multiple component carriers, the device comprising:
a message confirmation unit to receive a radio resource control connection reconfiguration message transmitted from an evolved Node B (eNB), and to determine at least one reconfiguration from among CC addition, CC modification, and CC release;
a CC configuration-information confirmation unit to determine CC configuration information including CC index information associated with CCs that are set using variable indices based on a reference CC determined based on priorities of CCs in an RRC layer, the CC configuration information being included in the received RRC connection reconfiguration message and being distinguished from CC identification information allocated for distinguishing CCs in a physical (PHY) layer; and
a CC determination unit to select at least one CC based on the CC configuration information associated with reconfiguration determined by the message confirmation unit.

2. The CC reconfiguring device of claim 1, wherein the CC configuration information includes one or more information from among CC unique information corresponding to a constant and absolute value that distinguishes a CC in the physical (PHY) layer and variable CC index information that indicates the same CC that is mapped by the CC unique information; and
the CC index information indicates the same value as a Carrier Index Field (CIF), forming a Physical Downlink Control Channel (PDCCH), of a L1 layer.

3. The CC reconfiguring device of claim 2, wherein the CC determination unit performs 1) mapping of CC index information to a corresponding CC using CC index information and CC unique information included in the CC configuration information when the CC configuration information is transmitted for CC addition (Add), 2) updating corresponding CC information or changing mapping information between CC index information of each CC that is previously configured and a corresponding CC based on whether SI update notification (System Information Update Notification) exists in a case of CC modification (Modify), and 3)releasing a corresponding CC based on existing CC index information included in the CC configuration information in a case of CC release (Release).

4. The CC reconfiguring device of claim 2, wherein the CC unique information includes one or more information from among center frequency information of each CC, Physical Cell Identifier (PCI), and an Evolved Cell Global Identifier (ECGI).

5. The CC reconfiguring device of claim 2, wherein the CC index information is a variable and relative value that is logically allocated for distinguishing CCs allocated to the UE in an upper layer that is higher than or equal to L2.

6. The CC reconfiguring device of claim 1, further comprising:
a message transmitting/receiving unit to generate and transmit an RRC connection reconfiguration complete message after CC reconfiguration is completed.

7. The CC reconfiguring device of claim 1, wherein the message confirmation unit additionally performs one or more functions from among 1) a function of determining whether the received RRC connection reconfiguration message is an RRC connection reconfiguration message that is received first after an RRC connection re-establishment procedure, 2) a function of determining whether information indicating full configuration is included in the RRC connection reconfiguration message, 3) a function of determining whether a radio resource configuration dedicated message exists in the RRC connection reconfiguration message, and 4) a function of determining whether another reconfiguration structure information in addition to the radio resource configuration dedicated message is included in the RRC connection reconfiguration message.

8. The CC reconfiguring device of claim 1, wherein, when both uplink CC configuration information and downlink CC configuration information are included in CC configuration information included in an RRC connection reconfiguration message (RRCConnectionReconfiguration) that is received first after an RRC connection re-establishment procedure, and uplink CC configuration does not included in CC configuration information included in a subsequently received RRC connection reconfiguration message (RRCConnectionReconfiguration), a downlink CC configuration is changed based on information included in the reconfiguration message, and an uplink CC configuration is maintained to be the same as a previous status or a uplink CC is released.

9. A Component Carrier (CC) reconfiguration method in a communication system that uses multiple component carriers, the method comprising:
receiving a Radio Resource Control (RRC) connection reconfiguration message;
determining CC configuration information included in the RRC connection reconfiguration message;
performing CC reconfiguration by performing one or more procedures from among CC addition (Add), CC modification (Mod), and CC release (Release) based on the CC configuration information; and
generating and transmitting an RRC connection reconfiguration complete message.

10. The CC reconfiguration method of claim 9, wherein the CC configuration information comprises one or more information from among:
CC unique information including one or more information from among center frequency information of each CC, a Physical Cell Identifier (PCI), and an Evolved Cell Global Identifier (ECGI); and
CC index information used as an indicator that is mapped to CC unique information of each CC and distinguishes the corresponding CC.

11. The CC reconfiguration method of claim 10, wherein the CC reconfiguration comprises:
1) mapping CC index information to a corresponding CC using CC index information and CC unique information included in the CC configuration information when the CC configuration information is transmitted for CC addition (Add);
2) updating corresponding CC information or changing mapping information between CC index information of each CC that is previously configured and a corresponding CC based on whether SI update notification (System Information Update Notification) exists in a case of CC modification (Modify); and
3) releasing a corresponding CC based on existing CC index information included in the CC configuration information in a case of CC release (Release).

12. A Radio Resource Control (RRC) connection reconfiguration message transmitting device in a communication system that uses multiple component carriers, the device comprising:
a CC configuration information generating unit to generate, for each CC, CC configuration information to include one or more information from among CC unique information and separate CC index information that matches the CC unique information;
an RRC connection reconfiguration message generating unit to generate an RRC connection reconfiguration message to include the CC configuration information;
a message transmitting unit to transmit the generated RRC connection reconfiguration message; and
an RRC connection reconfiguration complete message receiving unit to receive an RRC connection reconfiguration complete message.

13. A Radio Resource Control (RRC) connection reconfiguration message transmitting method in a communication system that uses multiple component carriers, the method comprising:
generating, for each CC, CC configuration information to include one or more information from among CC unique information and separate CC index information that matches the CC unique information;
generating an RRC connection reconfiguration message to include the CC configuration information;
transmitting the generated RRC connection reconfiguration message; and
receiving an RRC connection reconfiguration complete message.
